(19) United States
(12) Patent Application Publication
(10) Pub. No.: US 2017/0058560 A1
(43) Pub. Date: Mar. 2, 2017

(54) LOCK

(71) Applicant: LINTEX CO., LTD., ZHANGHUA COUNTY (TW)

(72) Inventor: CHIA-SHENG LIN, ZHANGHUA COUNTY (TW)

(21) Appl. No.: 15/247,007

(22) Filed: Aug. 25, 2016

(30) Foreign Application Priority Data
Aug. 28, 2015 (TW) 104214024

(51) Int. Cl. E05B 9/08; E05B 9/04

(52) U.S. Cl. CPC E05B 9/084; E05B 9/04

(57) ABSTRACT

A lock is provided, including a shell body, a lock main body and an abutting assembly. The shell body is for being fixedly disposed on an object. The lock main body has a first end and a second end which is opposite to the first end, the second end has a first engaging portion, the lock main body is releasably and rotatably inserted into the shell body along a first direction, and the first direction is defined as a connection between the first end and the second end. The abutting assembly has a base, a second engaging portion, which is connected to the base and positionably engaged with the first engaging portion, and a lock plate which is connected to the base and driven by the lock main body, and the lock plate is for being optionally locked with the object.

### BACKGROUND OF THE INVENTION

Field of the Invention

The present invention relates to a lock.

Description of the Prior Art

Usually, to prevent others from opening personal objects or entering a room, the most direct method is to assemble a lock on an object to be opened. In this type of lock, a distal end of a lock main body has a lock plate assembled thereto, the lock main body can be actuated to rotate so as to switch the lock and the object to be opened to be in a released state or a locked state. When in the locked state, the lock plate interferes a movement of the object to be opened, so the object to be opened cannot be opened so as to protect personal safety or prevent things from being stolen.

As disclosed in TWM335553, TWM351245 and TWM493580, the lock plate and the lock main body are engaged with each other through an engaging portion which protrudes beyond a distal end of the lock main body, the engaging portion has an exterior threaded portion and is disposed through the lock plate to be engaged with a nut to fixedly clamp the lock plate so that the lock plate and the lock main body can rotate synchronously. In addition, as disclosed in TWM407941, the distal end of the lock main body has an inner threaded portion inwardly, and the lock plate clamps the distal end of the lock main body through a screw and a gasket.

However, in this type of prior arts, the lock main body is disposed through the lock plate, and the lock plate fixedly clamps the lock main body through another object (for example, the screw and the bolt) screwed with the engaging portion of the lock main body. It is time-consuming to assemble the lock because a user needs to continue screwing the object with the engaging portion tightly so as to make the lock plate and the engaging portion engaged with each other stably. Besides, after being used for a long time, the object which is used to screwed with the engaging portion get loose easily, and the user needs to screw the object tightly again.

The present invention has arisen to mitigate and/or obviate the afore-described disadvantages.

### SUMMARY OF THE INVENTION

The major object of the present invention is to provide a lock which can effectively decrease a time that a lock plate being assembled on a lock main body so as to elevate efficiency greatly. In addition, the lock plate can be engaged with an engaging portion firmly to prevent from loosing off from each other.

To achieve the above and other objects, a lock is provided, including a shell body, a lock main body and an abutting assembly. The shell body is for being fixedly disposed on an object. The lock main body has a first end and a second end which is opposite to the first end, the second end has a first engaging portion, the lock main body is releasably and rotatably inserted into the shell body along a first direction, and the first direction is defined as a connection between the first end and the second end. The abutting assembly has a base, a second engaging portion, which is connected to the base and positionably engaged with the first engaging portion, and a lock plate which is connected to the base and driven by the lock main body, and the lock plate is for being optionally locked with the object.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is another stereogram of the preferred embodiment of the present invention;

FIG. 3 is a breakdown view of the preferred embodiment of the present invention;

FIG. 4 is a partially-enlarged view of the preferred embodiment of the present invention;

FIG. 5 is a cross-sectional top view of the preferred embodiment of the present invention;

FIG. 6 is a cross-sectional side view of the preferred embodiment of the present invention; and

FIG. 7 is a breakdown view of another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

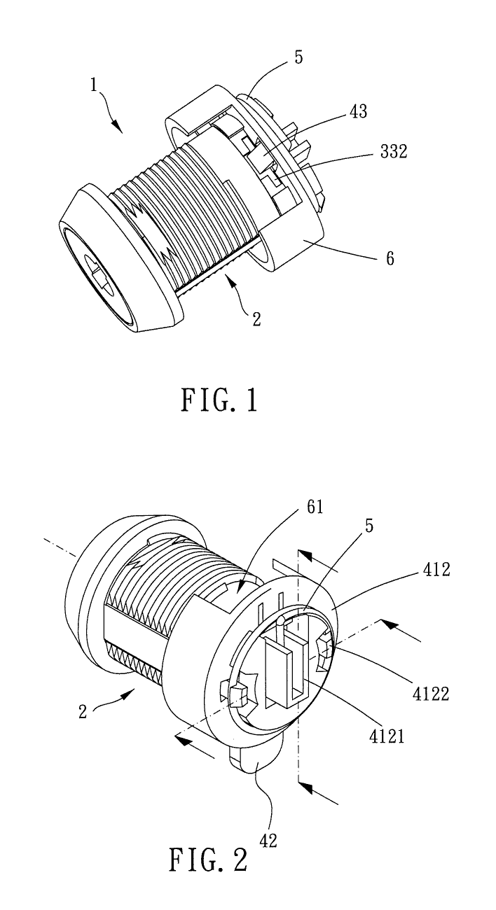

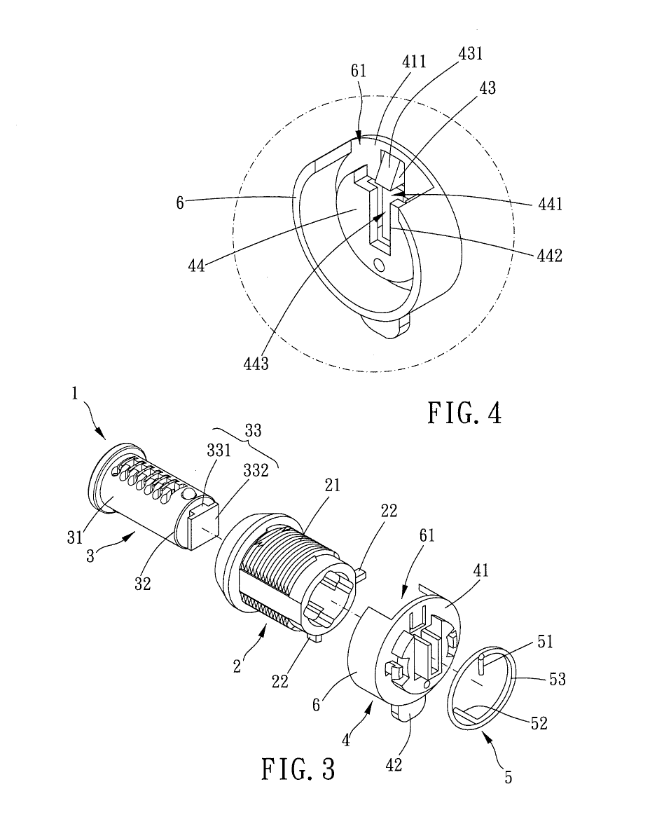

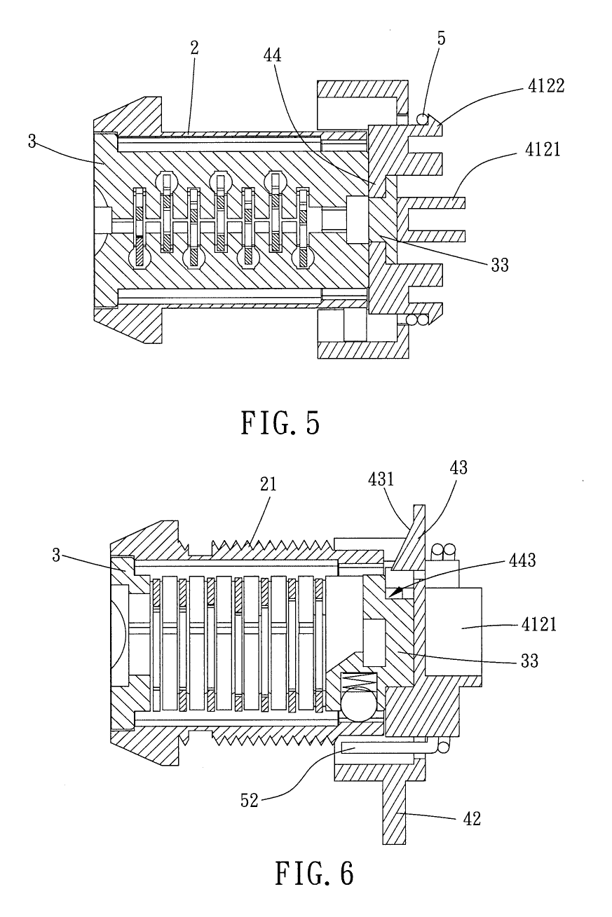

Please refer to FIGS. 1 to 6 for a preferred embodiment of the present invention. A lock 1 includes a shell body 2, a lock main body 3 and an abutting assembly 4.

The shell body 2 is for being fixedly disposed on an object (not shown). The lock main body 3 has a first end 31 which is for a key (not shown) to be inserted thereinto and a second end 32 which is opposite to the first end 31, the second end 32 has a first engaging portion 33, the lock main body 3 is releasably and rotatably inserted into the shell body 2 along a first direction, and the first direction is defined as a connection between the first end 31 and the second end 32. The abutting assembly 4 has a base 41, a second engaging portion 44, which is connected to the base 41 and positionably engaged with the first engaging portion 33, and a lock plate 42 which is connected to the base 41 and driven by the lock main body 3, and the lock plate 42 is for being optionally locked with the object.

To further describe an engaging way of the first and second engaging portions 33, 34, the second engaging portion 44 and the base 41 define a receiving space 443 which is open, and the first engaging portion 33 protrudes beyond the second end 32 and is received in the receiving space 443 to be engaged with the second engaging portion 44. Specifically, the second engaging portion 44 has a first opening 441 which is lateral to the first direction and communicates with an outside of the lock 1 and the receiving space 443 and a ditch 442 which is lateral to the first direction and communicates with the first opening 441 and the receiving space 443, and the first engaging portion 33 passes through the first opening 441 along the ditch 442 and enters the receiving space 443 so as to provide a quick positioning way and to make the lock plate 42 rotate with the lock main body synchronously. More specifically, the first engaging portion 33 has a first restricting portion 331 which is slidably arranged within the ditch 442 and a second restricting portion 332 which is laterally connected to the first restricting portion 331, and the second restricting portion 332 passes through the first opening 441 and enters the receiving space 443. The ditch 442 can not only guide the first restricting portion 331 into the receiving space 443 but also laterally abut against the first restricting portion 331 to enhance an engagement of the base 41 and the lock main body 3 so as to prevent the base 41 from rotating relative to the lock main body 3.

Preferably, the base 41 further has a blocking portion 43 which is opposite to the base 41 and neighboring the first opening 441, the blocking portion 43 is reversibly deformable relative to the base 41, and the blocking portion 43 positionably restricts the second restricting portion 332 within the receiving space 443 to prevent the second restricting portion 332 from being detached from the first opening 441 during a rotation process; therefore, even after being used for a long time, the base 41 can still be engaged with the lock main body 3 tightly. In other words, the lock plate 42 can accurately rotate with the lock main body 3 synchronously. In this embodiment, as viewed along a direction perpendicular to the first direction, the first and second restricting portions 331, 332 form a substantially T shape, the abutting assembly 4 further has an annular peripheral portion 6 which extends laterally from a periphery of the base 41, the annular peripheral portion 6 has a second opening 61 which is opposite to the first opening 441, the blocking portion 43 is located between the first and second openings 441, 61, the blocking portion 43 has an inclined face 431, the inclined face 431 faces toward the first opening 441 and extends away from the base 41, and the second restricting portion 332 slides into the receiving space 443 through abutting against the inclined face 431. The annular peripheral portion 6 at least covers the shell body 2 partly to protect the shell body 2 and the first and second engaging portions 33, 44 from receiving unexpected impacts. In addition, the shell body 2 preferably has an exterior threaded portion 21 for being screwed with the object so that the shell body 2 can be engaged with the object directly. It is understandable that the exterior threaded portion 21 at least partially exposed outside the annular peripheral portion 6.

It is to be noted that the abutting assembly 4 preferably further has an elastic member 5, the elastic member 5 has a positioning end 51, an abutting end 52 and an elastic main body 53, the shell body 2 protrudes to form two position-restricting blocks 22 which are lateral to the first direction, the positioning end 51 is positioned on the base 41, and the abutting end 52 is disposed between the two position-restricting blocks 22 and optionally abuts against one of the two position-restricting blocks 22 laterally. The two position-restricting blocks 22 abut against the abutting end 52 laterally to restrict a rotation range of the lock main body 3; and when a force which drives the lock main body 3 to rotate is removed, the elastic member 5 automatically rebound the lock main body 3 to a preset position. Specifically, the base 41 has a first face 411 and a second face 412 which is opposite to the first face 411, the second engaging portion 44 is disposed on the first face 411, the second face 412 of the base 41 protrudes to form a positioning base 4121 and has two hook portions 4122 which are opposite to each other and extend along the first direction, the positioning base 4121 is located between the two hook portions 4122, and the elastic member 5 is substantially annular. The positioning end 51 is inserted into the positioning base 4121 and positioned on the positioning base 4121, when the abutting end 52 abuts against one said position-restricting block 22 laterally and the lock main body 3 is rotated continuously, the elastic main body 53 is actuated to reel along a circumferential direction of the base 41 so as to produce a rebound force to drive the lock main body 3 to the preset position. It is understandable that the elastic main body 53 is windably hooked on the two hook portions 4122 along the circumferential direction of the base 41.

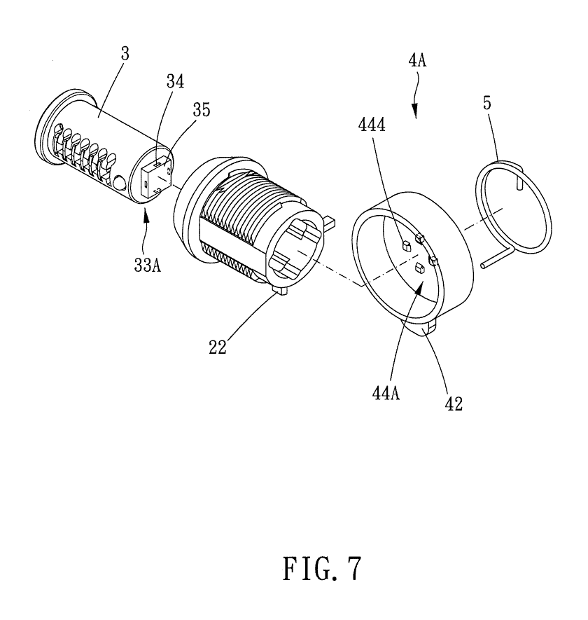

Of course, the first and second engaging portion 33, 44 may be engaged with each other in other ways. Please refer to FIG. 7 for another preferred embodiment, including a first engaging portion 33A, a second engaging portion 44A and an abutting assembly 4A, the first engaging portion 33A has at least one recessed portion 34, and the second engaging portion 44A has at least one third restricting portion 444 which is engaged with the at least one recessed portion 34. The first engaging portion 33A is a protrusive block 35, the protrusive block 35 has the at least one recessed portion 34, and the second engaging portion 44A extends along the first direction to form the at least one third restricting portion 444. Specifically, the protrusive block 35 is substantially a rectangular cuboid, each circumferential side of the protrusive block 35 respectively has one said recessed portion 34, the second engaging portion 44A has four said third restricting portions 444, each said third restricting portion 444 is respectively engaged with one said recessed portion 34, two of the four third restricting portions 444 and the other two of the four third restricting portions 444 are arranged symmetrically, and each said third restricting portion 444 is barbed. The user can push the abutting assembly 4A along the first direction to make each said third restricting portion 444 fixedly engaged with each said recessed portion 34. It is understandable that in other embodiments, the first engaging portion may have at least one third restricting portion, the second engaging portion may have at least one recessed portion, and vise versa.

Given the above, the lock of the present invention provides a way to quickly fix the lock plate so as to decrease a time needed to assemble the lock and to elevate the working efficiency. In addition, through being disposed through the receiving space and engaged, the base having the lock plate can be engaged with the lock main body firmly, and the lock plate is comovable with the lock main body synchronously.

In addition, the lock further has the elastic member, after the rotating force is removed, the elastic member automatically rebound the lock main body back to the preset position, and the user does not need to rotate the lock main body again.

While we have shown and described various embodiments in accordance with the present invention, it should be clear to those skilled in the art that further embodiments may be made without departing from the scope of the present invention.

What is claimed is:

1. A lock, including:
a shell body, for being fixedly disposed on an object;
a lock main body, having a first end and a second end which is opposite to the first end, the second end having a first engaging portion, the lock main body being releasably and rotatably inserted into the shell body along a first direction, the first direction being defined as a connection between the first end and the second end;
an abutting assembly, having a base, a second engaging portion, which is connected to the base and positionably engaged with the first engaging portion, and a lock plate which is connected to the base and driven by the lock main body, the lock plate for being optionally locked with the object.

2. The lock of claim 1, wherein the abutting assembly further has an elastic member, the elastic member has a positioning end, an abutting end and an elastic main body, the shell body protrudes to form two position-restricting blocks which are lateral to the first direction, the positioning end is positioned on the base, and the abutting end is disposed between the two position-restricting blocks and optionally abuts against one of the two position-restricting blocks laterally.

3. The lock of claim 2, wherein the base has a first face and a second face which is opposite to the first face, the second engaging portion is disposed on the first face, the second face of the base protrudes to form a positioning base and has two hook portions which are opposite to each other and extend along the first direction, the elastic member is substantially annular, the positioning end is positioned on the positioning base, and the elastic main body is windably hooked on the two hook portions along a circumferential direction of the base.

4. The lock of claim 1, wherein the second engaging portion and the base define a receiving space which is open, and the first engaging portion protrudes beyond the second end and is received in the receiving space to be engaged with the second engaging portion.

5. The lock of claim 4, wherein the second engaging portion has a first opening which is lateral to the first direction and communicates with an outside of the lock and the receiving space and a ditch which is lateral to the first direction and communicates with the first opening and the receiving space, and the first engaging portion passes through the first opening along the ditch and enters the receiving space.

6. The lock of claim 5, wherein the first engaging portion has a first restricting portion which is slidably arranged within the ditch and a second restricting portion which is laterally connected to the first restricting portion, and the second restricting portion passes through the first opening and enters the receiving space.

7. The lock of claim 6, wherein the base further has a blocking portion which is opposite to the base and neighboring the first opening, the blocking portion is reversibly deformable relative to the base, and the blocking portion positionably restricts the second restricting portion within the receiving space.

8. The lock of claim 7, wherein as viewed along a direction perpendicular to the first direction, the first and second restricting portions form a substantially T shape, the abutting assembly further has an annular peripheral portion which extends laterally from a periphery of the base, the annular peripheral portion has a second opening which is opposite to the first opening, the blocking portion is located between the first and second openings, the blocking portion has an inclined face, the inclined face faces toward the first opening and extends away from the base, the second restricting portion slides into the receiving space through abutting against the inclined face, and the annular peripheral portion at least covers the shell body partly.

9. The lock of claim 1, wherein the first engaging portion has at least one recessed portion, and the second engaging portion has at least one third restricting portion which is engaged with the at least one recessed portion.

10. The lock of claim 9, wherein the first engaging portion is a protrusive block, the protrusive block has the at least one recessed portion, and the second engaging portion extends along the first direction to form the at least one third restricting portion.

11. The lock of claim 10, wherein the protrusive block is substantially a rectangular cuboid, each circumferential side of the protrusive block respectively has one said recessed portion, the second engaging portion has four said third restricting portions, each said third restricting portion is respectively engaged with one said recessed portion, two of the four third restricting portions and the other two of the four third restricting portions are arranged symmetrically, and each said third restricting portion is barbed.
